(19) United States
(12) Patent Application Publication
(10) Pub. No.: US 2025/0083623 A1
(43) Pub. Date: Mar. 13, 2025

(54) SUSPENDED STRUCTURE OF LOWER PART OF VEHICLE

(71) Applicant: Honda Motor Co., Ltd., Tokyo (JP)

(72) Inventor: Yasuo SHIMIZU, Tokyo (JP)

(73) Assignee: Honda Motor Co., Ltd., Tokyo (JP)

(21) Appl. No.: 18/826,140

(22) Filed: Sep. 5, 2024

(30) Foreign Application Priority Data
Sep. 7, 2023 (JP) 2023-145684
Jul. 22, 2024 (JP) 2024-117238

(51) Int. Cl. B60R 16/02

(52) U.S. Cl. CPC B60R 16/0215

(57) ABSTRACT

A suspended structure for suspending a suspended object from a lower part of a vehicle includes: a front structure connected to the lower part of the vehicle and connected to a vehicle front side of the suspended object; and a rear structure connected to the lower part of the vehicle and connected to a vehicle rear side of the suspended object. The rear structure is configured to guard the suspended object from the rear of the vehicle and detach from the lower part of the vehicle in response to a predetermined pushing force being applied from the rear of the vehicle. The front structure is configured so that at least a portion deforms to allow the suspended object to escape toward the front of the vehicle in response to the rear structure detaching from the lower part of the vehicle.

### CROSS-REFERENCE TO RELATED APPLICATION

This application claims the priority benefits of Japanese application no. 2023-145684, filed on Sep. 7, 2023, and Japanese application no. 2024-117238, filed on Jul. 22, 2024. The entirety of the above-mentioned patent applications is hereby incorporated by reference herein and made a part of this specification.

### BACKGROUND

### Technical Field

The disclosure relates to a suspended structure in a lower part of a vehicle, primarily a BEV (battery electric vehicle).

### Description of Related Art

As the development of vehicle electrification progresses, there is an increasing need to dispose parts and units required for electrification on the lower surface of a vehicle (for example, Patent Documents 1 to 4 (Japanese Patent No. 6974512, Japanese Patent Application Laid-Open No. 2022-081322, Japanese Patent Application Laid-Open No. 2004-161056, and Japanese Patent Application Laid-Open No. 2006-44537)). In particular, various requirements arise for the layout of the E-Axle (a unit that integrates a motor and a reduction mechanism) on the vehicle and the inverter that controls the motor drive. The E-Axle that drives the rear wheels is required to be disposed on the rear subframe in the rear lower part of the vehicle, while the inverter that controls it is often required to be disposed in the front of the vehicle. Then, the harness connecting these has to be routed under the vehicle, and for convenience in assembly, a relay connector may be disposed in between. The relay connector is placed at an end of the harness and is covered with a case of an aluminum casting. Then, the relay connector is suspended from the vehicle body in the lower part of the vehicle and in front of the rear subframe.

However, when a large load is applied to the vehicle from behind due to a collision or the like, the rear subframe is pushed toward the front of the vehicle. This may cause the rear subframe to come into contact with the relay connector. If the rear subframe comes into direct contact with the relay connector or if the energy of the load is entirely absorbed by the relay connector, the relay connector carrying a high voltage may be affected by the load, resulting in malfunction such as ground fault and short circuit. Therefore, there is a need to prevent the rear subframe from directly transmitting the load from the rear to the relay connector, and to prevent the energy of the load from being absorbed by the relay connector as much as possible.

The disclosure provides a suspended structure of a lower part of a vehicle that is capable of preventing the structure at the rear of a vehicle from coming into direct contact with the suspended object even if a load is applied to the vehicle from behind, and reducing the influence of the load on the suspended object.

### SUMMARY

The suspended structure of the disclosure is a suspended structure (1) for suspending a suspended object (100) from a lower part of a vehicle (200), which includes: a front structure (10) connected to the lower part of the vehicle (200) and connected to a vehicle front side of the suspended object (100); and a rear structure (20) connected to the lower part of the vehicle (200) and connected to a vehicle rear side of the suspended object (100), in which the rear structure (20) is configured to guard the suspended object (100) from a rear of the vehicle and detach from the lower part of the vehicle in response to a predetermined pushing force being applied from the rear of the vehicle, and the front structure (10) is configured so that at least a portion deforms to allow the suspended object (100) to escape toward a front of the vehicle in response to the rear structure (20) detaching from the lower part of the vehicle.

### BRIEF DESCRIPTION OF THE DRAWINGS

FIG. 1 is a perspective view schematically showing a suspended structure according to an embodiment of the disclosure.

FIG. 2 is an exploded perspective view of the suspended structure of FIG. 1.

FIG. 3 is a front view showing a state where the suspended structure of FIG. 1 is attached to a vehicle body.

FIG. 4A to FIG. 4D are transition views showing the change when a pushing force is applied from the rear to the suspended structure of FIG. 1, wherein FIG. 4A shows a state before the force is applied, FIG. 4B shows a state immediately after the force is applied, FIG. 4C shows a state immediately before the rear stay 21 detaches from the vehicle body, and FIG. 4D shows a state where the rear stay has detached from the vehicle body and the front structure has deformed for the suspended object to escape.

FIG. 5 is a graph showing the change in force acting on the suspended structure of FIG. 1.

### DESCRIPTION OF THE EMBODIMENTS

The suspended structure of the disclosure is a suspended structure (1) for suspending a suspended object (100) from a lower part of a vehicle (200), which includes: a front structure (10) connected to the lower part of the vehicle (200) and connected to a vehicle front side of the suspended object (100); and a rear structure (20) connected to the lower part of the vehicle (200) and connected to a vehicle rear side of the suspended object (100), in which the rear structure (20) is configured to guard the suspended object (100) from a rear of the vehicle and detach from the lower part of the vehicle in response to a predetermined pushing force being applied from the rear of the vehicle, and the front structure (10) is configured so that at least a portion deforms to allow the suspended object (100) to escape toward a front of the vehicle in response to the rear structure (20) detaching from the lower part of the vehicle.

With this configuration, the structure at the rear of the vehicle does not come into direct contact with the suspended object even if a load is applied to the vehicle from behind, and the influence of the load on the suspended object can be reduced.

It is preferable that the front structure (10) includes: a front bracket (11) connected to the lower part of the vehicle (200); and a front stay (12) connected to the front bracket (11) and the suspended object (100) and being easily deformable.

With this configuration, the deformation function of the front structure can be realized by deforming at least the front stay.

It is preferable that the front bracket (11) is composed of a metal plate including a web portion (11a), a plurality of arm portions (11c), and a flange portion (11b), and having a substantially hat shape in a side view of the vehicle, the plurality of arm portions (11c) are connected to the vehicle (200), the web portion (11a) is connected to the front stay (12), the front stay (12) is composed of a metal plate including a web portion (12a), a first flange portion (12b), and a second flange portion (12c), and having a substantially Z shape in a side view of the vehicle, the first flange portion (12b) is connected to the front bracket (11), and the second flange portion (12c) is connected to the suspended object (100).

With this configuration, the front bracket can maintain connection with the vehicle even when a load is applied to the vehicle from behind, by connecting to the vehicle with the plurality of arm portions, and the front stay has a substantially Z shape in a side view of the vehicle, which allows the front stay to be easily deformed when receiving a force from the rear.

The front stay (12) and the suspended object (100) may be connected by screwing a bolt (BT) into a screw hole (101) provided in the suspended object (100) through a through hole (12e) drilled in the second flange portion (12c) of the front stay (12).

With this configuration, the front stay and the suspended object can be detachably connected, ensuring ease of assembly and maintenance.

The front bracket (11) and the front stay (12) may be connected by inserting a weld bolt (WB) joined to the web portion (11a) of the front bracket (11) into a through hole (12d) drilled in the first flange portion (12b) of the front stay (12) and screwing a nut (NT) onto the weld bolt (WB).

With this configuration, the weld bolt does not fall off from the front bracket, so maintenance is easy, and the front bracket and the front stay can be firmly connected.

The plurality of arm portions (11c) of the front bracket (11) may be connected to the vehicle (200) by welding.

This configuration allows the front bracket and the vehicle to be firmly connected, and can prevent the suspended structure from falling off when a load is applied to the vehicle.

It is preferable that, in the front stay (12), a connection portion with the suspended object (100) and a connection portion with the front bracket (11) are offset in a vehicle lateral direction.

With this configuration, the front stay can be deformed more easily.

A plate thickness of the front stay (12) may be greater than a plate thickness of the front bracket (11).

This configuration also allows the front bracket to be easily deformed.

It is preferable that the rear structure (20) includes: a rear stay (21) connected to the lower part of the vehicle (200) and connected to the suspended object (100); and a rear bracket (22) connected to the rear stay (21) and connected to the suspended object (100) to guard the suspended object (100) from the rear of the vehicle, in which the rear stay (21) is configured to detach from the lower part of the vehicle (200) in response to a predetermined pushing force being applied to the rear bracket (22) from the rear of the vehicle.

With this configuration, the rear bracket can prevent a force from the rear from directly acting on the suspended object, and can also prevent the rear bracket from being crushed by the rear stay detaching from the lower part of the vehicle.

The rear stay (21) may be composed of a substantially flat metal plate, a vehicle front side may be connected to the suspended object (100), a vehicle rear side may be connected to the vehicle (200), and connected to the rear bracket (22) between a connection portion with the suspended object (100) and a connection portion with the vehicle (200). The rear bracket (22) may be composed of a metal plate including a web portion (22a), a first flange portion (22b), and a second flange portion (22c). The first flange portion (22b) may be connected to the rear stay (21), the second flange portion (22c) may be connected to the suspended object (100), and the web portion (22a) may be disposed at a position that opens a predetermined gap from the suspended object (100) and shields a part or entirety of the rear of the vehicle.

This configuration can realize the guard function of the rear bracket and the connection structure of the rear stay and the rear bracket.

The rear stay (21) may include a slit-shaped cut portion (21a) from the rear of the vehicle in a connection portion with the vehicle (200), and may be connected to the vehicle (200) by fastening a bolt (BT) through the slit-shaped cut portion (21a), and a width of the slit-shaped cut portion (21a) may be greater than an outer diameter of a threaded portion of the bolt (BT) and smaller than a diameter of a head portion.

This configuration can realize the function for detaching the rear stay from the lower part of the vehicle.

The bolt (BT) fastening the rear stay (21) and the vehicle (200) may be only one bolt. In response to a load of a predetermined value or more being applied forward to the rear stay (21), the bolt (BT) may be configured to detach from the slit-shaped cut portion (21a) of the rear stay (21) due to slippage between the bolt fastening the vehicle (200) and the rear stay (21).

These configurations can realize the function for detaching the rear stay from the lower part of the vehicle.

The rear stay (21) and the suspended object (100) may be connected by screwing a bolt (BT) into a screw hole (102) provided in the suspended object (100) through a through hole (21b) drilled in the rear stay (21). Further, the rear bracket (22) and the suspended object (100) may be connected by screwing a bolt (BT) into a screw hole (103) provided in the suspended object (100) through a through hole (22d) drilled in the second flange portion (22c).

With these configurations, the rear stay and the rear bracket can be detachably connected to the suspended object, ensuring ease of assembly and maintenance.

The rear stay (21) and the rear bracket (22) may be connected by welding.

This configuration allows the rear bracket and the rear stay to be firmly connected, which do not require separation during maintenance, and when a predetermined pushing force is applied to the rear bracket from the rear of the vehicle, the rear stay can reliably detach from the lower part of the vehicle together with the rear bracket.

A plate thickness of the rear stay (21) may be greater than a plate thickness of the rear bracket (22).

This configuration can prevent the rear stay from being deformed even when a load is applied to the vehicle, thereby ensuring the function of detaching from the vehicle.

The suspended object (100) may be a relay connector that relays a harness mounted on the vehicle (200), the suspended object (100) may be a relay connector that is mounted on a vehicle (200) and relays a harness connecting an inverter and a motor of an electric vehicle, and the suspended object (100) may be a relay connector that has a case of an aluminum alloy casting.

These configurations can prevent damage to the connector when a load is applied to the vehicle, and prevent a ground fault or short circuit to the outside of the current flowing between the inverter and the motor of an electric vehicle.

The suspended structure according to the disclosure includes the rear structure configured to guard the suspended object from the rear of the vehicle and detach from the lower part of the vehicle when a predetermined pushing force is applied from the rear of the vehicle, and the front structure configured so that at least a portion deforms to allow the suspended object to escape toward the front of the vehicle when the rear structure detaches from the lower part of the vehicle. Therefore, the structure at the rear of the vehicle does not come into direct contact with the suspended object even if a load is applied to the vehicle from behind, and the influence of the load on the suspended object can be reduced.

Hereinafter, embodiments of the disclosure will be described in detail with reference to the accompanying drawings.

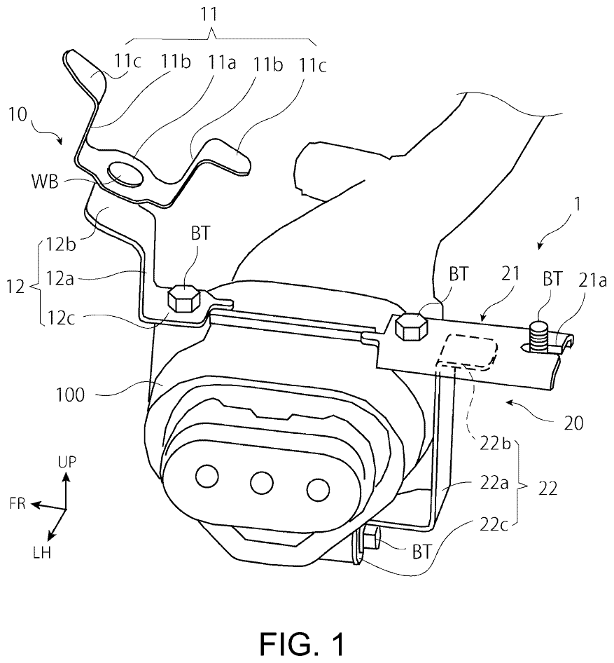

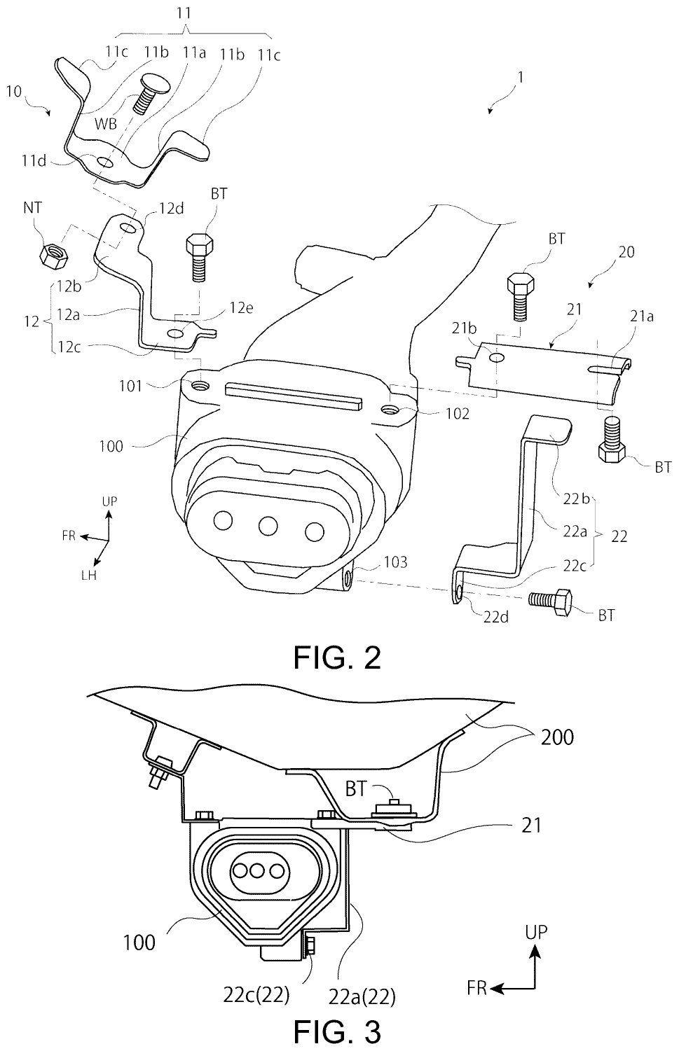

FIG. 1 is a perspective view schematically showing a suspended structure 1 according to an embodiment of the disclosure, and FIG. 2 is an exploded perspective view thereof. The suspended structure 1 of this embodiment is a structure for suspending a relay connector 100 as a suspended object from the lower part of a vehicle 200 (see FIG. 3), and is configured to include a front structure 10 and a rear structure 20.

The front structure 10 is a structure that connects the lower part of the vehicle 200 and the vehicle front side (hereinafter, also simply referred to as “front side”) of the relay connector 100, and includes a front bracket 11 and a front stay 12 in this embodiment.

The front bracket 11 is a component that is connected to the lower part of the vehicle 200. As shown in FIG. 1 or FIG. 2, the front bracket 11 is a component formed by bending a metal plate into a substantially hat shape in a side view, and includes a central web portion 11a, two flange portions 11b bending and extending from both sides thereof at a substantially right angle in the same direction, and two arm portions 11c bending and extending from the tips of the respective flange portions 11b at a right angle to open to both sides.

As shown in FIG. 3, the two arm portions 11c are respectively fixed to the lower part of the vehicle 200. In this embodiment, the two arm portions 11c of the front bracket 11 are connected to the vehicle 200 by welding.

This configuration allows the front bracket 11 and the vehicle 200 to be firmly connected, and can prevent the relay connector 100, which is the suspended object, from falling off when a load is applied to the vehicle. However, the disclosure is not limited to this configuration, and for example, the front bracket 11 may be fixed by screwing a bolt into a screw hole provided in the vehicle 200. Further, the number of arm portions 11c is not limited to two, but may be three or more.

In addition, as shown in FIG. 1 and FIG. 2, the web portion 11a is connected to the front stay 12 which will be described later. In this embodiment, as shown in FIG. 2, a weld bolt WB inserted into a through hole 11d of the web portion 11a is welded and jointed to the web portion 11a of the front bracket 11, and the web portion 11a is connected by screwing a nut NT through the through hole 12d drilled in the first flange portion 12b of the front stay 12.

With this configuration, the weld bolt WB does not fall off from the front bracket 11, so maintenance is easy, and the front bracket 11 and the front stay 12 can be firmly connected. However, the disclosure is not limited to this configuration, and for example, the front bracket 11 and the front stay 12 may be fixed using normal bolts and nuts.

The front stay 12 is a component that connects the front bracket 11 and the relay connector 100, and is easily deformable. As shown in FIG. 1 and FIG. 2, the front stay 12 is a component formed by bending a metal plate into a substantially Z shape in a side view, and includes a central web portion 12a, a first flange portion 12b, and a second flange portion 12c. The first flange portion 12b is connected to the web portion 11a of the front bracket 11, and the second flange portion 12c is connected to the relay connector 100.

With this configuration having a substantial Z shape in the vehicle side view, the front stay 12 can be easily deformed when receiving a force from the rear of the vehicle (hereinafter, also simply referred to as “rear”). However, the disclosure is not limited to this configuration, and the front stay 12 may have any shape as long as the front stay 12 is easily deformable.

In this embodiment, as shown in FIG. 2, the second flange portion 12c of the front stay 12 and the relay connector 100 are connected by screwing a bolt BT into a screw hole 101 provided in the relay connector 100 through a through hole 12e drilled in the second flange portion 12c.

With this configuration, the front stay 12 and the relay connector 100, which is the suspended object, can be detachably connected, ensuring ease of assembly and maintenance. However, the disclosure is not limited to this configuration, and the front stay 12 and the relay connector 100, which is the suspended object, may be connected by any connection structure.

In this embodiment, as shown in FIG. 1 and FIG. 2, in the front stay 12, a joint portion with the relay connector 100 and a joint portion with the front bracket 11 are offset in the vehicle lateral direction.

With this configuration, a moment is applied to the front stay 12 when receiving a force from the rear, so the front stay 12 can be deformed more easily. Further, the web portion 12a approaches the first flange portion 12b if the amount of deformation of the front stay 12 increases, but by offsetting the joint portions in the vehicle left-right direction, the crushed web portion 12a can approach the first flange portion 12b without interfering with the weld bolt WB and the nut NT, so the amount of deformation movement and the amount of absorbed energy can be increased. However, the disclosure is not limited to this configuration, and the joint portion with the relay connector 100 and the joint portion with the front bracket 11 may not be offset as long as the front stay 12 or the front bracket is sufficiently easily deformable.

Furthermore, the plate thickness of the front stay 12 is formed to be greater than the plate thickness of the front bracket 11. In other words, the plate thickness of the front bracket 11 is formed to be smaller than the plate thickness of the front stay 12. This configuration also allows the front bracket 11 to be easily deformable. However, the disclosure is not limited to this configuration, and the plate thickness of the front stay 12 may be the same as or smaller than the plate thickness of the front bracket 11 as long as the front stay 12 or the front bracket is sufficiently easily deformable.

On the other hand, the rear structure 20 is a structure that is configured to guard the suspended object from the rear of the vehicle and detach from the lower part of the vehicle when a predetermined pushing force is applied from the rear of the vehicle, and in this embodiment, as shown in FIG. 1 and FIG. 2, the rear structure 20 is configured to include a rear stay 21 and a rear bracket 22.

The rear stay 21 is a member that is connected to the lower part of the vehicle 200 and connected to the relay connector 100, which is the suspended object, and is composed of a substantially flat metal plate. The vehicle front side of the rear stay 21 is connected to the relay connector 100 and the vehicle rear side of the rear stay 21 is connected to the vehicle 200, and the rear stay 21 is connected to the rear bracket 22 between the connection point with the relay connector 100 and the connection point with the vehicle 200.

As shown in FIG. 1 and FIG. 2, the rear stay 21 includes a slit-shaped cut portion 21a from the rear of the vehicle at the connection point with the vehicle 200, and is connected to the vehicle 200 by fastening a bolt BT through the slit-shaped cut portion 21a. The width of the slit-shaped cut portion 21a is formed to be greater than the outer diameter of the threaded portion of the bolt BT and smaller than the diameter of the head portion.

This configuration can realize the function for detaching the rear stay 21 from the lower part of the vehicle 200.

In this embodiment, the rear stay 21 and the vehicle 200 are fastened by only one bolt BT. The bolt BT is configured to detach from the slit-shaped cut portion 21a of the rear stay 21 due to slippage between the bolt BT that fastens the vehicle 200 and the rear stay 21 when a load of a predetermined value or more is applied forward to the rear stay 21.

These configurations can realize the function for detaching the rear stay from the lower part of the vehicle.

Further, as shown in FIG. 2, the rear stay 21 and the relay connector 100, which is the suspended object, are connected by screwing a bolt BT into a screw hole 102 provided in the relay connector 100 through a through hole 21b drilled in the rear stay 21.

With this configuration, the rear stay 21 can be detachably connected to the relay connector 100, ensuring ease of assembly and maintenance. However, the disclosure is not limited to this configuration, and the rear stay 21 and the relay connector 100, which is the suspended object, may be connected by any connection structure.

As shown in FIG. 1 and FIG. 2, the rear bracket 22 is a member that is connected to the rear stay 21 and the relay connector 100 and guards the relay connector 100 from the rear of the vehicle, and is composed of a metal plate that includes a web portion 22a, a first flange portion 22b, and a second flange portion 22c. The first flange portion 22b is connected to the rear stay 21 and the second flange portion 22c is connected to the relay connector 100, and the web portion 22a is disposed at a position that opens a predetermined gap from the relay connector 100 and shields a part or the entirety of the rear of the vehicle.

This configuration can realize the guard function of the rear bracket 22 and the connection structure of the rear stay 21 and the rear bracket 22.

As shown in FIG. 2, the rear bracket 22 and the relay connector 100 are connected by screwing a bolt BT into a screw hole 103 provided in the relay connector 100 through a through hole 22d drilled in the second flange portion 22c.

With this configuration, the rear bracket 22 can be detachably connected to the relay connector 100, ensuring ease of assembly and maintenance. However, the disclosure is not limited to this configuration, and the rear bracket 22 and the relay connector 100, which is the suspended object, may be connected by any connection structure.

The rear stay 21 and the first flange portion 22b of the rear bracket 22 are connected by welding.

This configuration allows the rear bracket 22 and the rear stay 21 to be firmly connected, which do not require separation during maintenance, and when a predetermined pushing force is applied to the rear bracket 22 from the rear of the vehicle, the rear stay 21 can reliably detach from the lower part of the vehicle 200 together with the rear bracket 22. However, the disclosure is not limited to this configuration, and the rear stay 21 and the rear bracket 22 may be connected by any connection structure as long as the connection structure is strong enough to reliably detach the rear bracket 22 together with the rear stay 21 from the lower part of the vehicle 200.

Further, in this embodiment, the plate thickness of the rear stay 21 is formed to be greater than the plate thickness of the rear bracket 22.

This configuration can prevent the rear stay 21 from being deformed even when a load is applied to the vehicle, thereby ensuring the function of detaching from the vehicle. However, the disclosure is not limited to this configuration, and the plate thickness of the rear stay 21 may be the same as or smaller than the plate thickness of the rear bracket 22 as long as deformation of the rear stay 21 can be prevented to ensure the function of detaching from the vehicle.

In this embodiment, the relay connector 100 that relays the harness mounted on the vehicle is used as the suspended object, but the relay connector 100 may be a relay connector that relays a harness connecting an inverter and a motor of an electric vehicle or may be a relay connector that has a case of an aluminum alloy casting.

These configurations can prevent damage to the connector when a load is applied to the vehicle, and prevent a ground fault or short circuit to the outside of the current flowing between the inverter and the motor of an electric vehicle.

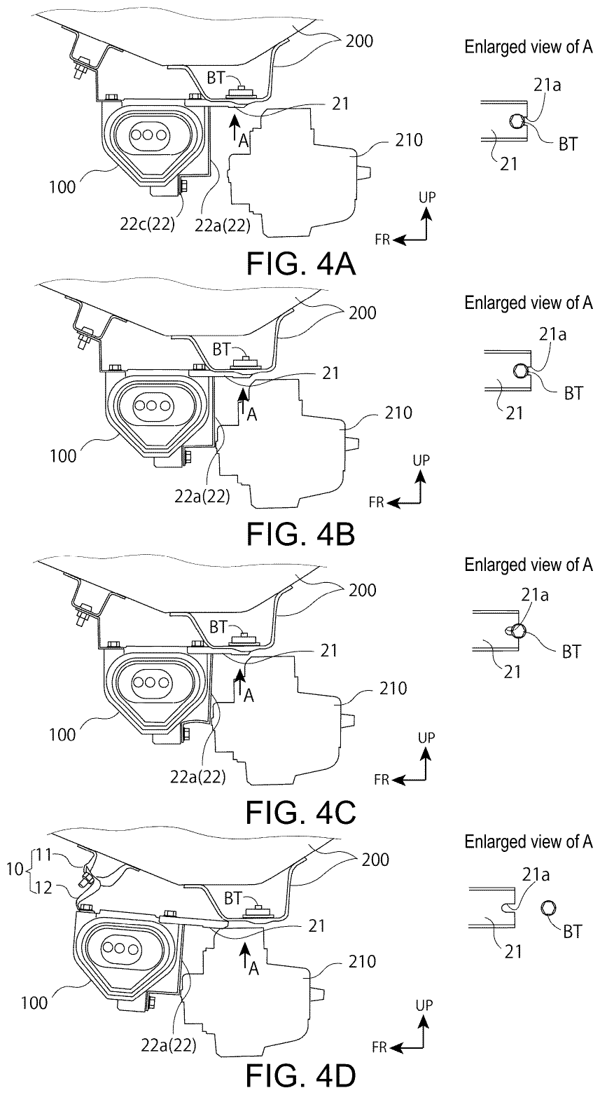

Next, the operation of the suspended structure 1 of this embodiment configured as above during a vehicle rear-end collision will be described. FIG. 4A to FIG. 4D are transition views showing the change when the rear subframe 210 is pushed forward from the rear and a load is applied to the suspended structure 1 from behind during a rear-end collision of the vehicle, wherein FIG. 4A shows a state before the force is applied, FIG. 4B shows a state immediately after the force is applied, FIG. 4C shows a state immediately before the rear stay 21 detaches from the vehicle body, and FIG. 4D shows a state where the rear stay 21 has detached from the vehicle body and the front structure 10 has deformed for the relay connector 100 to escape.

FIG. 4A shows a state before a pushing force is applied to the suspended structure 1 from the rear. In this state, the rear stay 21 is connected to the lower part of the vehicle 200, and the bolt BT fixes the rear stay 21 at the back of the slit-shaped cut portion 21a (see FIG. 1 and FIG. 2). The rear bracket 22 connected to the rear stay 21 has the second flange portion 22c connected to the relay connector 100, and the web portion 22a is positioned at a predetermined distance from the outer peripheral portion of the relay connector 100.

Next, FIG. 4B shows a state immediately after the rear subframe 210 comes into contact with the rear bracket 22. In this state, the pushing force applied to the rear bracket 22 is transmitted and applied to the rear stay 21 as well, but the web portion 22a of the rear bracket 22 is not destroyed and guards the relay connector 100, and the rear stay 21 also maintains the connection with the lower part of the vehicle 200.

Next, FIG. 4C shows a state where the rear subframe 210 further pushes the rear bracket 22 of the suspended structure 1, causing the rear bracket 22 to elastically deform but still hold up. When the pushing force applied to the rear stay 21 reaches a predetermined value, slippage occurs between the bolt BT that fastens the vehicle 200 and the rear stay 21, causing the bolt BT to come out of the slit-shaped cut portion 21a (see FIG. 1 and FIG. 2) and the rear stay 21 to detach.

Next, FIG. 4D shows a state where the rear stay 21 has detached. As a result of the detachment of the rear stay 21, the pushing force is applied to the front structure 10, the Z shape of the front stay 12 is deformed, and the front bracket 11 is also deformed, to prevent the relay connector 100 and the rear structure 20 from falling off and allow these to escape forward.

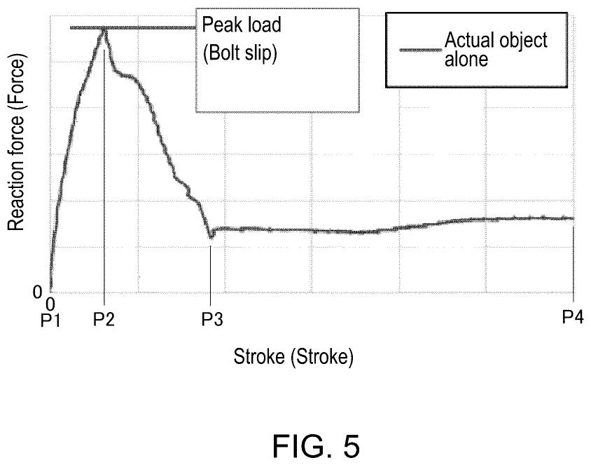

FIG. 5 is a graph showing the change in force acting on the suspended structure 1, and shows the change in force applied to the suspended structure 1 when a structure corresponding to the rear subframe 210 of the vehicle was pushed statically from the rear to the rear bracket 22. The horizontal axis represents the stroke (Stroke) of the structure, and the vertical axis represents the measured value of the reaction force (Force) received by the structure, which corresponds to the force applied to the suspended structure 1 (hereinafter, simply referred to as “force applied to the suspended structure 1”).

At P1 (stroke of 0), in the state corresponding to FIG. 4B, the structure comes into contact with the rear bracket 22, and the force applied to the suspended structure 1 begins to increase.

At P2, in the state corresponding to FIG. 4C, the stroke progresses due to elastic deformation of the rear bracket 22. When the force applied to the suspended structure 1 reaches a predetermined value, slippage occurs between the bolt BT that fastens to the vehicle 200 and the rear stay 21. Thereafter, the force applied to the suspended structure 1 drops sharply.

At P3, in the state corresponding to FIG. 4D, the bolt BT comes completely out of the slit-shaped cut portion 21a, and the rear stay 21 detaches from the vehicle.

Thereafter, since the suspended structure 1 and the relay connector 100 are connected to the vehicle 200 only through the front structure 10, that is, the front bracket 11 and the front stay 12, as the deformation progresses, the suspended structure 1 and the relay connector 100 move forward and progress to P4. At this time, the force received by the suspended structure 1 is a relatively weak reaction force against the deformation of the front structure 10.

In addition, even in a state where the rear bracket 22 receives a strong pushing force before the rear stay 21 detaches from the vehicle 200 in the event of the above-mentioned vehicle rear-end collision, this pushing force is mainly borne by the rear bracket 22 and the rear stay 21, so the force applied to the relay connector 100 is further reduced. Furthermore, since the rear bracket 22 guards the relay connector 100, damage to the relay connector 100 due to contact with protruding portions of the rear subframe 210 or the like can be prevented.

Thus, the suspended structure 1 of this embodiment includes the rear structure 20 configured to guard the relay connector 100, which is the suspended object, from the rear of the vehicle and detach from the lower part of the vehicle 200 when a predetermined pushing force is applied from the rear of the vehicle, and the front structure 10 configured so that at least a portion deforms to allow the relay connector 100, which is the suspended object, to escape toward the front of the vehicle when the rear structure 20 detaches from the lower part of the vehicle 200. Therefore, the structure at the rear of the vehicle 200 does not come into direct contact with the relay connector 100 even if a load is applied to the vehicle 200 from behind, and the influence of the load on the relay connector 100 can be reduced.

Although the embodiment of the disclosure has been described above, the disclosure is not limited to the above-described embodiment, and various modifications are possible within the scope of the claims and the scope of the technical ideas illustrated in the specification and drawings. For example, in the above embodiment, the relay connector 100 is used as the suspended object, but the disclosure is not limited thereto, and the suspended object may be any object that can be suspended from the lower part of the vehicle 200, such as an on-vehicle battery.

Further, in this embodiment, the front structure and the rear structure are configured as two independent structures with no portion directly connected to each other, but as long as the two structures have the same configuration and function and ultimately achieve the same effect, the front structure and the rear structure may be configured as a single structure having a connecting portion, which is also within the technical scope of the disclosure.

Further, in this embodiment, the front structure is configured to be easily deformable and the rear structure is configured to be detachable from the vehicle, but this configuration can be switched back and forth so as to cope with a load from the front. Alternatively, the installation direction can be changed in the left-right direction so as to cope with a load from the left-right direction.

What is claimed is:

1. A suspended structure of a lower part of a vehicle for suspending a suspended object from the lower part of the vehicle, the suspended structure comprising:
a front structure connected to the lower part of the vehicle and connected to a vehicle front side of the suspended object; and
a rear structure connected to the lower part of the vehicle and connected to a vehicle rear side of the suspended object,
wherein the rear structure is configured to guard the suspended object from a rear of the vehicle and detach from the lower part of the vehicle in response to a predetermined pushing force being applied from the rear of the vehicle, and
the front structure is configured so that at least a portion deforms to allow the suspended object to escape toward a front of the vehicle in response to the rear structure detaching from the lower part of the vehicle.

2. The suspended structure of the lower part of the vehicle according to claim 1, wherein the front structure comprises:
a front bracket connected to the lower part of the vehicle; and
a front stay connected to the front bracket and the suspended object and being easily deformable.

3. The suspended structure of the lower part of the vehicle according to claim 2, wherein the front bracket is composed of a metal plate comprising a web portion, a plurality of arm portions, and a flange portion, and having a substantially hat shape in a side view of the vehicle,
the plurality of arm portions are connected to the vehicle,
the web portion is connected to the front stay,
the front stay is composed of a metal plate comprising a web portion, a first flange portion, and a second flange portion, and having a substantially Z shape in a side view of the vehicle,
the first flange portion is connected to the front bracket, and
the second flange portion is connected to the suspended object.

4. The suspended structure of the lower part of the vehicle according to claim 3, wherein the front stay and the suspended object are connected by screwing a bolt into a screw hole provided in the suspended object through a through hole drilled in the second flange portion of the front stay.

5. The suspended structure of the lower part of the vehicle according to claim 3, wherein the front bracket and the front stay are connected by inserting a weld bolt joined to the web portion of the front bracket into a through hole drilled in the first flange portion of the front stay and screwing a nut onto the weld bolt.

6. The suspended structure of the lower part of the vehicle according to claim 3, wherein the plurality of arm portions of the front bracket are connected to the vehicle by welding.

7. The suspended structure of the lower part of the vehicle according to claim 2, wherein in the front stay, a connection portion with the suspended object and a connection portion with the front bracket are offset in a vehicle lateral direction.

8. The suspended structure of the lower part of the vehicle according to claim 2, wherein a plate thickness of the front stay is greater than a plate thickness of the front bracket.

9. The suspended structure of the lower part of the vehicle according to claim 2, wherein the rear structure comprises:
a rear stay connected to the lower part of the vehicle and connected to the suspended object; and
a rear bracket connected to the rear stay and connected to the suspended object to guard the suspended object from the rear of the vehicle,
wherein the rear stay is configured to detach from the lower part of the vehicle in response to a predetermined pushing force being applied to the rear bracket from the rear of the vehicle.

10. The suspended structure of the lower part of the vehicle according to claim 9, wherein the rear stay is composed of a substantially flat metal plate,
a vehicle front side is connected to the suspended object,
a vehicle rear side is connected to the vehicle, and
connected to the rear bracket between a connection portion with the suspended object and a connection portion with the vehicle,
the rear bracket is composed of a metal plate comprising a web portion, a first flange portion, and a second flange portion,
the first flange portion is connected to the rear stay,
the second flange portion is connected to the suspended object, and
the web portion is disposed at a position that opens a predetermined gap from the suspended object and shields a part or entirety of the rear of the vehicle.

11. The suspended structure of the lower part of the vehicle according to claim 10, wherein the rear stay comprises a slit-shaped cut portion from the rear of the vehicle in a connection portion with the vehicle, and is connected to the vehicle by fastening a bolt through the slit-shaped cut portion, and
a width of the slit-shaped cut portion is greater than an outer diameter of a threaded portion of the bolt and smaller than a diameter of a head portion.

12. The suspended structure of the lower part of the vehicle according to claim 11, wherein the rear stay is connected to the vehicle by only one bolt.

13. The suspended structure of the lower part of the vehicle according to claim 11, wherein in response to a load of a predetermined value or more being applied toward the front of the vehicle to the rear stay, the bolt detaches from the slit-shaped cut portion of the rear stay due to slippage between the bolt and the rear stay.

14. The suspended structure of the lower part of the vehicle according to claim 10, wherein the rear stay and the suspended object are connected by screwing a bolt into a screw hole provided in the suspended object through a through hole drilled in the rear stay.

15. The suspended structure of the lower part of the vehicle according to claim 10, wherein the rear bracket and the suspended object are connected by screwing a bolt into a screw hole provided in the suspended object through a through hole drilled in the second flange portion.

16. The suspended structure of the lower part of the vehicle according to claim 10, wherein the rear stay and the rear bracket are connected by welding.

17. The suspended structure of the lower part of the vehicle according to claim 10, wherein a plate thickness of the rear stay is greater than a plate thickness of the rear bracket.

18. The suspended structure of the lower part of the vehicle according to claim 1, wherein the suspended object is a relay connector that relays a harness mounted on the vehicle.

19. The suspended structure of the lower part of the vehicle according to claim 1, wherein the suspended object is a relay connector that is mounted on a vehicle and relays a harness connecting an inverter and a motor of an electric vehicle.

20. The suspended structure of the lower part of the vehicle according to claim 1, wherein the suspended object is a relay connector that has a case of an aluminum alloy casting.
